(19) United States
(12) Patent Application Publication
(10) Pub. No.: US 2021/0215498 A1
(43) Pub. Date: Jul. 15, 2021

(54) INFRASTRUCTURE ARTICLES WITH DIFFERENTIATED SERVICE ACCESS USING PATHWAY ARTICLE CODES AND ON-VEHICLE CREDENTIALS

(71) Applicant: 3M INNOVATIVE PROPERTIES COMPANY, St. Paul, MN (US)

(72) Inventor: Andrew D. DUBNER, St. Paul, MN (US)

(73) Assignee: 3M Innovative Properties Company, St. Paul, MN (US)

(21) Appl. No.: 17/054,875

(22) PCT Filed: Jun. 5, 2019
(86) PCT No.: PCT/IB2019/054680

§ 371 Date: Nov. 12, 2020

Related U.S. Application Data
(60) Provisional application No. 62/681,901, filed on Jun. 7, 2018.

(51) Int. Cl. G01C 21/36; G06Q 50/30; G06K 19/06; B60W 60/00

(52) U.S. Cl. CPC G01C 21/3602; G06Q 50/30; B60W 2420/42; B60W 60/001; B60W 60/005; G06K 19/06103

(57) ABSTRACT

In some examples, a system includes: a pathway article having a code embodied thereon and positioned proximate to a vehicle pathway, wherein the code comprises a service indicator that corresponds to a remote service accessible to a pathway-article assisted vehicle (PAAV); and the pathway-article assisted vehicle (PAAV) comprising: at least one image capture device configured to generate an image of the code embodied on the vehicle pathway; a computing device configured to: process the image to obtain the service indicator from the code; send, to the remote service, a request comprising the service indicator included in the pathway article that is encoded with a the credential configured in the PAAV to restrict access to the service indicator; and receive a response from the remote service that is generated based at least in part on the service indicator included in the pathway article and the credential.

### TECHNICAL FIELD

The present application relates generally to pathway articles and systems in which such pathway articles may be used.

### BACKGROUND

Current and next generation vehicles are increasingly including fully automated guidance system vehicles, semi-automated guidance system vehicles, and fully manual vehicles. Semi-automated vehicles may include those with advanced driver assistance systems (ADAS) that may be designed to assist drivers avoid accidents. Automated and semi-automated vehicles may include adaptive features that may automate lighting, provide adaptive cruise control, automate braking, incorporate GPS/traffic warnings, connect to smartphones, alert driver to other cars or dangers, keep the driver in the correct lane, show what is in blind spots and other features. Infrastructure may increasingly become more intelligent by including systems to help vehicles move more safely and efficiently such as installing sensors, communication devices and other systems. Over the next several decades, vehicles of all types—manual, semi-automated and automated—may operate on the same roads and may need to operate cooperatively and synchronously for safety and efficiency.

### SUMMARY

In general, this disclosure describes techniques and systems for using pathway articles and on-vehicle credentials to access differentiated services which may be implemented at the vehicle or remote computing devices. For example, a vehicle pathway, such as a roadway, may include pathway articles (e.g., roadway sign) positioned at locations proximate to the pathway. The pathway article may include an optical code that is machine-readable by an image capture device and is visually decodable to particular data. In some examples, the image capture device may be included within a pathway-article assisted vehicle (PAAV) that uses information from pathway articles during operation of the vehicle.

In accordance with techniques of this disclosure, a PAAV and/or an operator of a PAAV (e.g., drivers and/or passengers) may use or otherwise process information from one or more services, such as provided by a remote computing device. Unlike conventional, remotely accessible services, techniques of this disclosure may use an on-PAAV credential (e.g., credential configured at the PAAV) to access services that provide information based on an optical code of a pathway article. In this way, techniques of this disclosure may use a combination of an on-PAAV credential and information from the pathway article to access differentiated services provided by remote computing devices. In contrast to conventional, remotely accessible services, the services described in this disclosure provide information based on the optical code of the pathway article itself and the on-PAAV credential. Information in the optical code of the pathway article that is provided by the PAAV to remote computing device may be contextually relevant to the location of the pathway article and therefore the PAAV that is proximate to the pathway article, thereby improving the relevance, quality, and/or timeliness (to name only a few advantages) of the information provided by the differentiated services of the remote computing device.

By using an on-PAAV credential with information of the optical code in PAAV-generated requests sent to access differentiated services of remote computing device, an operator of the PAAV and/or operators of remote computing device can “unlock” or otherwise access or provide access to different services that provide information which is contextually relevant to the location of the pathway article and the PAAV proximate to the pathway article. For instance, information in the optical code of the pathway article may be encrypted, hashed, or otherwise protected by a component of the PAAV (e.g., image capture device) such that the information of the optical code can only be interpreted or used if the information is decrypted or the protection is otherwise removed. As such, encrypted information of the optical code generated by a PAAV component that is sent to a remote service may be decrypted by a service provider of the remote service to provide service data to the PAAV. In this way, accessibility to services provided by the remote computing device may be differentiated among different PAAVs based on the on-PAAV credential used to encrypt information in the optical code of the pathway article. Moreover, the information from the optical code that is encrypted by a component in the vehicle (e.g., image capture device) may not be accessible to other components within the PAAV unless decrypted. Accordingly, operators of remote computing devices can offer and control access to different tiers or types of services (in some examples, with different costs, pricing, service levels, availability, information content, etc.) and operators of PAAVs can securely access and/or purchase different tiers or types of the services that provide information which is contextually relevant to the location of the pathway article and the PAAV proximate to the pathway article.

In some examples, access to and use of a particular service may be based on the on-PAAV credential and a service credential associated with the particular service. For instance, a request from a PAAV that is received by the remote service may be encrypted or otherwise protected by the on-PAAV credential. The remote service may provide a response to the PAAV if a combination of the data in the request (e.g., infrastructure code data) and the service credential provide valid authentication to the remote service. If the combination of the data in the request and the service credential do not provide valid authentication to the remote service, then the remote service may a response that the authentication is invalid. By using on-PAAV credential and a service credential to access the remote service, techniques and systems of this disclosure may be provide a more secure framework for providing distributed services and may enable multiple different service providers to configure remote services where access to such services is controlled by a service credential of the service provider in combination with the on-PAAV credential. In some examples, the on-PAAV credential and service credential may be independently generated and controlled, while in other examples, the on-PAAV credential may be based on the service credential or the service credential may be based on the on-PAAV credential.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example system with a pathway article that is configured to be interpreted by a PAAV, in accordance with techniques of this disclosure.

FIG. 2 is a block diagram illustrating an example computing device, in accordance with one or more aspects of the present disclosure.

FIG. 3 is a flow diagram illustrating example operations of a computing device, in accordance with one or more techniques of this disclosure.

FIG. 4 is a conceptual diagram of a cross-sectional view of a pathway article in accordance with techniques of this disclosure.

FIGS. 5A and 5B illustrate cross-sectional views of portions of an article message formed on a retroreflective sheet, in accordance with one or more techniques of this disclosure.

FIG. 6 is a flow diagram illustrating example operation of a computing device, in accordance with one or more techniques of this disclosure.

### DETAILED DESCRIPTION

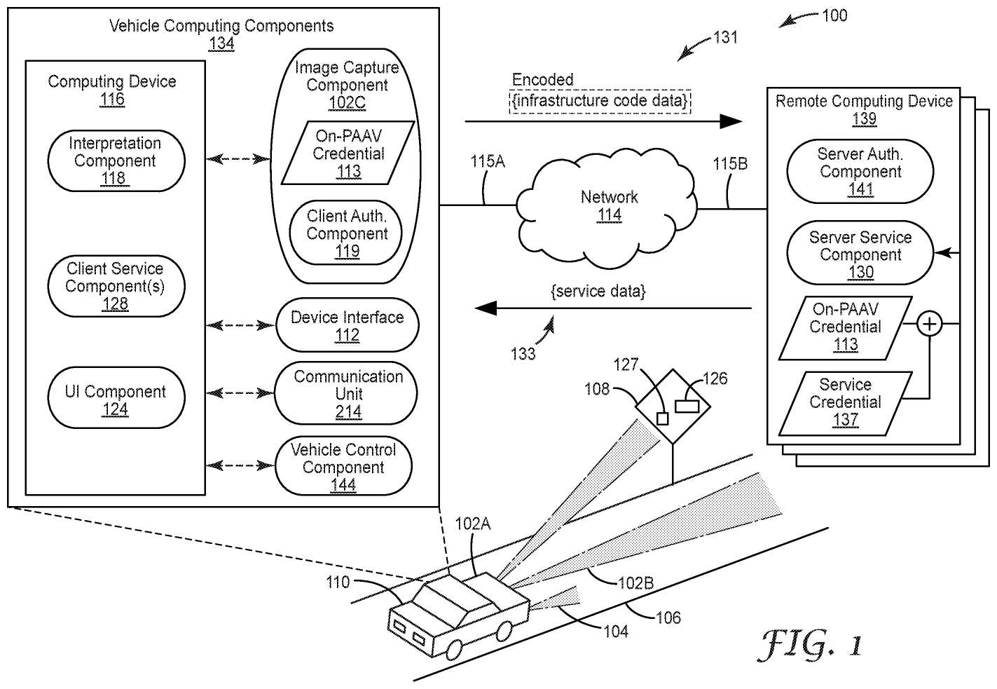

FIG. 1 is a block diagram illustrating an example system 100 with a pathway article 108 that is configured to be interpreted by a PAAV 110, in accordance with techniques of this disclosure. As described herein, PAAV 110 generally refers to a vehicle with a vision system, along with other sensors, that may interpret the vehicle pathway and the vehicle's environment, such as other vehicles or objects. PAAV 110 may interpret information from the vision system and other sensors, make decisions, and take actions to navigate the vehicle pathway. In this disclosure, a vehicle may include any vehicle with or without sensors, such as a vision system, to interpret a vehicle pathway.

As shown in FIG. 1, system 100 includes PAAV 110 that may operate on vehicle pathway 106 and that includes image capture devices 102A and 102B and computing device 116. The illustrated example of system 100 also includes one or more pathway articles 108 having a code 126 embodied thereon as described in this disclosure.

Vehicle pathway 106 may be a road, highway, a warehouse aisle, factory floor, or a pathway not connected to the earth's surface. Vehicle pathway 106 may include portions not limited to the pathway itself. In the example of a road, vehicle pathway 106 may include the road shoulder, physical structures near the pathway such as toll booths, railroad crossing equipment, traffic lights, the sides of a mountain, guardrails, and generally encompassing any other properties or characteristics of the pathway or objects/structures in proximity to the pathway.

PAAV 110 of system 100 may be an autonomous or semi-autonomous vehicle, such as an ADAS, that takes cues from vehicle pathway 106 using vision systems or other sensors. In some examples, PAAV 110 may include occupants that may take full or partial control of PAAV 110. PAAV 110 may be any type of vehicle designed to carry passengers or freight including small electric powered vehicles, large trucks or lorries with trailers, vehicles designed to carry crushed ore within an underground mine, or similar types of vehicles. PAAV 110 may include lighting, such as headlights in the visible light spectrum as well as light sources in other spectrums, such as infrared. Some examples of PAAVs may include the fully autonomous vehicles and ADAS equipped vehicles mentioned above, as well as unmanned aerial vehicles (UAV) (aka drones), human flight transport devices, underground pit mining ore carrying vehicles, forklifts, factory part or tool transport vehicles, ships and other watercraft and similar vehicles.

PAAV 110 may use various sensors to perceive the environment, infrastructure, and other objects around the vehicle. PAAV 110 may include other sensors such as radar, sonar, lidar, GPS and communication links for the purpose of sensing the vehicle pathway, other vehicles in the vicinity, environmental conditions around the vehicle and communicating with infrastructure. For example, a rain sensor may operate the vehicles windshield wipers automatically in response to the amount of precipitation, and may also provide inputs to the onboard computing device 116. These various sensors combined with onboard computer processing may allow the automated system to perceive complex information and respond to it more quickly than a human driver, as will be explained further below.

As shown in FIG. 1, PAAV 110 of system 100 may include image capture devices 102A and 102B, collectively referred to as image capture devices 102. Although techniques of this disclosure are described with respect an image capture device, other suitable sensors such as LiDAR may be used to perform the various techniques of this disclosure. Image capture devices 102 may convert light or electromagnetic radiation sensed by one or more image capture sensors into information, such as digital image or bitmap comprising a set of pixels. Each pixel may have chrominance and/or luminance components that represent the intensity and/or color of light or electromagnetic radiation. In general, image capture devices 102 may be used to gather information about pathway 106. Image capture devices 102 may send image capture information to computing device 116 via image capture component 102C. Image capture devices 102 may capture lane markings, centerline markings, edge of roadway or shoulder markings, as well as the general shape of the vehicle pathway. The general shape of a vehicle pathway may include turns, curves, incline, decline, widening, narrowing or other characteristics. Image capture devices 102 may have a fixed field of view or may have an adjustable field of view. An image capture device with an adjustable field of view may be configured to pan left and right, up and down relative to PAAV 110 as well as be able to widen or narrow focus. In some examples, image capture devices 102 may include a first lens and a second lens. PAAV 110 may have more or fewer image capture devices 102 in various examples.

Image capture devices 102 may include one or more image capture sensors and one or more light sources. In some examples, image capture devices 102 may include image capture sensors and light sources in a single integrated device. In other examples, image capture sensors or light sources may be separate from or otherwise not integrated in image capture devices 102. As described above, PAAV 110 may include light sources separate from image capture devices 102. Examples of image capture sensors within image capture devices 102 may include semiconductor charge-coupled devices (CCD) or active pixel sensors in complementary metal-oxide-semiconductor (CMOS) or N-type metal-oxide-semiconductor (NMOS, Live MOS) technologies. Digital sensors include flat panel detectors. In one example, image capture devices 102 includes at least two different sensors for detecting light in two different wavelength spectrums.

In some examples, one or more light sources 104 include a first source of radiation and a second source of radiation. In some embodiments, the first source of radiation emits radiation in the visible spectrum, and the second source of radiation emits radiation in the near infrared spectrum. In other embodiments, the first source of radiation and the second source of radiation emit radiation in the near infrared spectrum. As shown in FIG. 1, one or more light sources 104 may emit radiation in the near-infrared spectrum.

In some examples, image capture devices 102 captures frames at 50 frames per second (fps). Other examples of frame capture rates include 60, 30 and 25 fps. It should be apparent to a skilled artisan that frame capture rates are dependent on application and different rates may be used, such as, for example, 100 or 200 fps. Factors that affect required frame rate are, for example, size of the field of view (e.g., lower frame rates can be used for larger fields of view, but may limit depth of focus), and vehicle speed (higher speed may require a higher frame rate).

In some examples, image capture devices 102 may include one or more channels. The channels may be optical channels. The two optical channels may pass through one lens onto a single sensor. In some examples, image capture devices 102 includes at least one sensor, one lens and one band pass filter per channel The band pass filter permits the transmission of multiple near infrared wavelengths to be received by the single sensor. The at least two channels may be differentiated by one of the following: (a) width of band (e.g., narrowband or wideband, wherein narrowband illumination may be any wavelength from the visible into the near infrared); (b) different wavelengths (e.g., narrowband processing at different wavelengths can be used to enhance features of interest, such as, for example, an enhanced sign of this disclosure, while suppressing other features (e.g., other objects, sunlight, headlights)); (c) wavelength region (e.g., broadband light in the visible spectrum and used with either color or monochrome sensors); (d) sensor type or characteristics; (e) time exposure; and (f) optical components (e.g., lensing).

In some examples, image capture devices 102A and 102B may include an adjustable focus function. For example, image capture device 102B may have a wide field of focus that captures images along the length of vehicle pathway 106, as shown in the example of FIG. 1. Computing device 116 may control image capture device 102A to shift to one side or the other of vehicle pathway 106 and narrow focus to capture the image of pathway article 108, or other features along vehicle pathway 106. The adjustable focus may be physical, such as adjusting a lens focus, or may be digital, similar to the facial focus function found on desktop conferencing cameras. In the example of FIG. 1, image capture devices 102 may be communicatively coupled to computing device 116 via image capture component 102C. Image capture component 102C may receive image information from the plurality of image capture devices, such as image capture devices 102, perform image processing, such as filtering, amplification and the like, and send image information to computing device 116.

Other vehicle computing components 134 of PAAV 110 that may communicate with computing device 116 may include image capture component 102C, described above, device interface 112, and communication unit 214. In some examples image capture component 102C, device interface 112, and communication unit 214 may be separate from computing device 116 and in other examples may be a component of computing device 116.

In the example of FIG. 1, pathway 106 includes pathway article 108, which may be proximate to (i.e. in, adjacent, or leading up to) pathway 106. Pathway article 108 may include a variety of indicators and/or markers. For example, pathway article 108 may include one or more of an optical tag, a road sign, a pavement marker, a radio-frequency identification integrated circuit or RFID tag, an acoustic surface pattern, and a material configured to provide a RADAR signature to a RADAR system.

Pathway article 108 in FIG. 1 includes code 126. Code 126 may be detectable by at least one image capture device, such as image capture devices 102, mounted within PAAV 110. Code 126 may include, but is not limited to characters, images, and/or any other information that may be printed, formed, or otherwise embodied on pathway article 108. For example, pathway article 108 may have a physical surface having code 126 embodied thereon. In some examples, code 126 may be encoded via a 2-dimensional bar code. Examples of codes are described in PCT applications PCT/US2017/053777, PCT/US2017/053788, and PCT/US2017/053801, the content of each of which is expressly incorporated by reference herein in its entirety. Additional examples of physical surfaces having a code 126 embodied thereon are described in further detail below.

In some cases, a value associated with code 126 may be stored to a Radio Frequency IDentification (RFID) device and accessible using an RFID reader of PAAV 110. In some cases, computing device 116 may access the value associated with code 126 using other types of communications, such as Near-field communication (NFC) protocols and signals; RADAR, laser, or infrared-based readers, or other communication type. In some cases, code 126 may not be affixed to a separate pathway article.

As will be described further below, code 126 may indicate a variety of types of information. In some examples, code 126 may provide computing device 116 with static information. Static information may include any information that is not subject to change. For instance, pathway article 108 may be a STOP sign. Code 126 may indicate information that is representative of a sign type “STOP”. In some examples, code 126 may provide computing device 116 with dynamic information. Dynamic information may include any information that is subject to change. For example, certain features of a region near pathway article 108 may be unique and/or change frequently, such that code 126 may correspond to a classification or operating characteristic that is subject to change based on the changing features and updated based on the changing features. In some examples, the region may be a physical region comprising an area of pathway 106, an area outside of pathway 106, an area above pathway 106, and/or an area below pathway 106. In some examples, code 126 may indicate a link to an external computing device, such as remote computing device 139, that provides a service. In some examples, the link may be data, such as a Uniform Resource Identifier, pointer value, or any other lookup value.

In some examples, pathway article 108 includes additional components that convey other types of information, such as one or more security elements. For example, a security element may be any portion of code 126 that is printed, formed, or otherwise embodied on pathway article 108 that facilitates the detection of counterfeit pathway articles. Pathway article 108 may also include additional information that represents navigational characteristics of vehicle pathway 106 that may be printed, or otherwise disposed in locations that do not interfere with the graphical symbols. In some examples, pathway article 108 may include components of code 126 that do not interfere with the graphical symbols by placing the additional machine readable information so it is detectable outside a visible light spectrum. This may have advantages of avoiding interfering with a human operator interpreting pathway article 108, providing additional security. For example, code 126 of an enhanced sign may be formed by different areas that either retroreflect or do not retroreflect light, non-visible components in FIG. 1 may be printed, formed, or otherwise embodied in a pathway article using any light reflecting technique in which information may be determined from non-visible components. For instance, non-visible components may be printed using visibly-opaque, infrared-transparent ink and/or visibly-opaque, infrared-opaque ink. In some examples, non-visible components may be placed on pathway article 108 by employing polarization techniques, such as right circular polarization, left circular polarization or similar techniques.

In some examples, pathway article 108 includes one or more signs having image data embodied thereon, the image data encoded with the code. For example, pathway article 108 may include a physical surface having an optical element embodied thereon, such that the optical element embodies the code. In some examples, pathway article 108 may further include an article message that includes a human-perceptible representation of pathway information for the vehicle pathway.

In some examples, pathway article 108 may be an enhanced sign that includes a reflective, non-reflective, and/or retroreflective sheeting attached to a base surface of the enhanced sign. The sheeting has a physical surface and may include authentication information, such as the security elements described above. In this example, a reflective, non-reflective, and/or retroreflective sheet may be applied to a base surface using one or more techniques and/or materials including but not limited to: mechanical bonding, thermal bonding, chemical bonding, or any other suitable technique for attaching retroreflective sheet to a base surface. A base surface may include any surface of an object (such as described above, e.g., an aluminum plate) to which the reflective, non-reflective, and/or retroreflective sheet may be attached. An article message may be printed, formed, or otherwise embodied on the sheeting using any one or more of an ink, a dye, a thermal transfer ribbon, a colorant, a pigment, and/or an adhesive coated film. In some examples, content is formed from or includes a multi-layer optical film, a material including an optically active pigment or dye, or an optically active pigment or dye.

Device interface 112 may include a wired or wireless connection to a smartphone, tablet computer, laptop computer or similar device. In some examples, computing device 116 may communicate via device interface 112 for a variety of purposes such as receiving traffic information, address of a desired destination or other purposes. In some examples computing device 116 may communicate to external networks 114, e.g. the cloud, via device interface 112. In other examples, computing device 116 may communicate via communication units 214.

One or more communication units 214 of computing device 116 may communicate with external devices by transmitting and/or receiving data. For example, computing device 116 may use communication units 214 to transmit and/or receive radio signals on a radio network such as a cellular radio network or other networks, such as networks 114. In some examples communication units 214 may transmit and receive messages and information to other vehicles, such as information interpreted from pathway article 108. In some examples, communication units 214 may transmit and/or receive satellite signals on a satellite network such as a Global Positioning System (GPS) network. In some examples, communications units 214 may transmit and/or receive data to a remote computing system, such as remote computing device 139, through network 114.

In the example of FIG. 1, computing device 116 includes an interpretation component 118, a client authentication component 119, one or more client service components 128, a user interface (UI) component 124, and a vehicle control component 144. Components 118, 119, 124, 128, and 144 may perform operations described herein using software, hardware, firmware, or a mixture of both hardware, software, and firmware residing in and executing on computing device 116 and/or at one or more other remote computing devices. In some examples, components 118, 119, 124, 128, and 144 may be implemented as hardware, software, and/or a combination of hardware and software.

Computing device 116 may execute components 118, 119, 124, 128, and 144 with one or more processors. Computing device 116 may execute any of components 118, 119, 124, 128, and 144 as or within a virtual machine executing on underlying hardware. Components 118, 119, 124, 128, and 144 may be implemented in various ways. For example, any of components 118, 119, 124, 128, and 144 may be implemented as a downloadable or pre-installed application or “app.” In another example, any of components 118, 119, 124, 128, and 144 may be implemented as part of an operating system of computing device 116. Computing device 116 may include inputs from sensors not shown in FIG. 1 such as engine temperature sensor, speed sensor, tire pressure sensor, air temperature sensors, an inclinometer, accelerometers, light sensor, and similar sensing components.

UI component 124 may include any hardware or software for communicating with a user of PAAV 110. In some examples, UI component 124 includes outputs to a user such as vehicle head unit, displays, such as a display screen, indicator or other lights, audio devices to generate notifications or other audible functions. UI component 124 may also include inputs such as knobs, switches, keyboards, touch screens or similar types of input devices.

Interpretation component 118 may be configured to receive an image of code 126 and process the image of code 126 to obtain code 126. For example, interpretation component 118 may be communicatively coupled to at least one of image capture devices 102 and configured to receive the image of code 126 from the at least one of image capture devices 102. Interpretation component 118 may be configured to process the image of code 126 to obtain code 126, such as by using image processing techniques. Although interpretation component 118 is illustrated as being implemented in computing device 116, in other examples interpretation component 118 may be implemented in image capture component 102C.

Once interpretation component 118 has obtained code 126, interpretation component 118 may be configured to interpret code 126 to obtain information. Although example techniques to interpret code 126 are described in this disclosure, other example techniques are described in PCT applications PCT/US2017/053777, PCT/US2017/053788, and PCT/US2017/053801, the content of each of which is expressly incorporated by reference herein in its entirety. In some examples, interpretation component 118 may use decoding information to determine or receive information related to services provided by remote computing device 139, as further described in this disclosure. In some examples, such as where decoding information regarding code 126 is stored on computing device 116, interpretation component 118 may obtain the information by looking up code 126 in a database or other log, or otherwise accessing services based on the information. In some examples, such as where decoding information regarding code 126 is stored remotely at remote computing device 139, interpretation component 118 may send code 126 or data representing code 126 to an external database for decoding, such as an external database of remote computing device 139. In this way, interpretation component 118 may provide information, directly or indirectly, to vehicle control component 144 related code 126.

In accordance with techniques of this disclosure, PAAV 110 and users of PAAV 110 (e.g., drivers and/or passengers) may use or otherwise process information from one or more services provided by remote computing device 139. Unlike conventional, remotely accessible services, techniques of this disclosure may use an on-PAAV credential (e.g., credential configured at the PAAV) to access services that provide information based on code 126 of a pathway article. In this way, techniques of this disclosure may use a combination of an on-PAAV credential and information from pathway article 108 to obtain information from differentiated services provided by remote computing device 139. In contrast to conventional, remotely accessible services, the services described in this disclosure provide information based on code 126 of the pathway article itself and the on-PAAV credential. Information in code 126 of the pathway article that is provided by the PAAV to remote computing device 139 may be contextually relevant to the location of the pathway article and therefore the PAAV proximate to the pathway article, thereby improving the relevance, quality, and/or timeliness (to name only a few advantages) of the information provided by the differentiated services of remote computing device 139.

By using an on-PAAV credential with information of code 126 in PAAV-generated requests sent to access differentiated services of remote computing device 139, operators of PAAV 110 and/or operators of remote computing device 139 can “unlock” or otherwise access or provide access to different services that provide information which is contextually relevant to the location of the pathway article and the PAAV proximate to the pathway article. For instance, information in the optical code of the pathway article may be encrypted, hashed, protected or otherwise encoded by a component of the PAAV (e.g., image capture device) such that the information of the optical code can only be interpreted or used if the information is decrypted or the protection is otherwise removed. As such, encrypted information of the optical code generated by a PAAV component that is sent to a remote service may be decrypted by a service provider of the remote service to provide service data to the PAAV. In this way, accessibility to services provided remote computing device 139 may be differentiated among different PAAVs based on the on-PAAV credential used to encrypt information in code 126 of the pathway article. Moreover, the information from the optical code that is encrypted by a component in the vehicle (e.g., image capture device) may not be accessible to other components within the PAAV unless decrypted. Accordingly, operators of remote computing device 139 can offer and control access to different tiers or types of services (in some examples, with different costs, pricing, service levels, availability, information content, etc.) and operators of PAAVs 110 can securely access and/or purchase different tiers or types of the services that provide information which is contextually relevant to the location of the pathway article and the PAAV proximate to the pathway article.

In some examples, access to and use of a particular remote service may be based on the on-PAAV credential and a service credential associated with the particular service. For instance, a request from a PAAV that is received by the remote service may be encrypted or otherwise protected by the on-PAAV credential. The remote service may provide a response to the PAAV if a combination of the data in the request (e.g., infrastructure code data) and the service credential provide valid authentication to the remote service. If the combination of the data in the request and the service credential do not provide valid authentication to the remote service, then the remote service may not provide a response based on the service. By using on-PAAV credential and a service credential to access the remote service, techniques and systems of this disclosure may be provide a more secure framework for providing distributed services and may enable multiple different service providers to configure remote services where access to such services is controlled by a service credential of the service provider in combination with the on-PAAV credential. In some examples, the on-PAAV credential and service credential may be independently generated and controlled, while in other examples, the on-PAAV credential may be based on the service credential or the service credential may be based on the on-PAAV credential.

In some examples, information of code 126 may include a service indicator. A service indicator may be a string of characters, a bitstring, a set of one or more characters or symbols, machine-interpretable compiled or encoded information, or any other information. In some examples, a service indicator may identify one or more remote services. In some examples, a service indicator may identify one or more functions associated with one or more remote services. In some examples, a service indicator may represent a Uniform Resource Identifier or other address in an addressing scheme. In some examples, a service indicator may be any data usable to obtain a response from a remote service.

In some examples, on-PAAV credential 113 may be any one or more authentication credentials or identifiers (whether unique or not) that enable remote computing device 139 to distinguish between one or more users and/or PAAVs. In some examples, on-PAAV credential 113 may be a symmetric key. In other examples, on-PAAV credential 113 may be a public key and/or a private key in a public key cryptography scheme. In still other examples, on-PAAV credential 113 may be a string or set of one or more characters or symbols.

On-PAAV credential 113 may be generated and/or managed in any number of ways. For instance, remote computing device 139 may generate on-PAAV credential 113 in association with other information associated with a user and/or PAAV. As an example, remote computing device 139 may generate on-PAAV credential 113 as a symmetric key, and the symmetric key may be further stored or otherwise associated by remote computing device 139 with an identifier that corresponds to a user and/or PAAV. In other examples, remote computing device 139 may request on-PAAV credential 113 from another service, operator, and/or computing device that manages credentials. As described in this disclosure, on-PAAV credential 113 may be a public and private key pair issued to a user, operator, and/or manufacturer of PAAV 110.

On-PAAV credential 113 may be stored within any component of PAAV 110. For instance, as shown in FIG. 1, on-PAAV credential 113 may be included within image capture component 102C. Image capture component 102C may include one or more sub-components, such as an image sensor and a microcontroller that further includes one or more processing components and memories or other storage components. In some examples, a memory in the image capture component may be read-only or may permit writing and reading of data. In some examples, a designer, manufacturer, installer, operator, or other custodian (whether temporary or not) of a component in PAAV 110 that includes on-PAAV credential 113 may write or otherwise configure a memory of the component to include on-PAAV credential 113.

In some examples, a manufacturer image capture component 102C may request on-PAAV credential 113 from remote computing device 139. The manufacturer may write or otherwise configure a memory of image capture component 102C with on-PAAV credential 113. In other examples, a manufacturer image capture component 102C may generate on-PAAV credential 113 and configure a memory of image capture component 102C with on-PAAV credential 113. The manufacturer may send on-PAAV credential 113 to remote computing device 139, such that one or more services may be provided by remote computing device 139 based at least in part on on-PAAV credential 113. Although the foregoing example is described with respect to a manufacturer or designer of image capture component 102C, the example could be described with respect to any component and/or any designer, manufacturer, installer, operator, and/or other custodian of the component.

In some examples, on-PAAV credential 113 may be static, such that it is written once to a memory of a component in vehicle computing components 134 and is not re-written at a least point in time. In other examples, on-PAAV credential 113 may expire, such that an updated on-PAAV credential 113 may be acquired from remote computing device 139, generated by a component of PAAV 110, or obtained/generated from a component residing at PAAV 110 or other computing device external to PAAV 110. In still other examples, on-PAAV credential 113 may be overwritten with a different credential (e.g., by authentication component 119).

Vehicle computing components 134 may include client authentication component 119. Client authentication component 119 may manage on-PAAV credential 113. For instance, client authentication component 119 may include interfaces, drivers, and/or other functionality to access on-PAAV credential 113 within PAAV 110. As an example, a component that stores on-PAAV credential 113, such as image capture component 102C, may restrict access to on-PAAV credential 113. Client authentication component 119 may authenticate or otherwise access on-PAAV credential 113, and encrypt, hash, protect, or otherwise encode information of optical code 126. In some examples, image capture component 102C may capture an image of optical code 126, and interpretation component 118 may determination information of optical code 126. Interpretation component 118 may send the information of optical code 126 to client authentication component 119, which may encode the information of optical code 126 using on-PAAV credential 113. Once encoded (e.g., encrypting in some examples), the information of optical code 126 may only be accessed with a corresponding service credential 137 that is capable of decoding (e.g., decrypting) the information of optical code 126. In some examples, other components within vehicle computing components 134 may not be able to access the information of optical code 126 that is encoded with on-PAAV credential 113 because these other components do not have service credential 137.

In some examples, client authentication component 119 may manage the lifecycle, reading and/or writing of on-PAAV credential 113. For example, as on-PAAV credential 113 expires (e.g., according to periodic schedule, asynchronous event, etc.), authentication component 119 may generate and/or receive an updated credential that replaces on-PAAV credential 113. In some examples, client authentication component 119 may receive an updated credential that replaces on-PAAV credential 113 and write the updated credential to a memory of the component that stores on-PAAV credential 113.

Client service component 128 may access services provided by remote computing device 139 using on-PAAV credential 113 and information from code 126. Vehicle computing components 134 may include multiple client service components. In some examples, a client service component may be an application executing as a userspace application in an in-vehicle operating system. In other examples, a client service component may be included as a component of an in-vehicle operating system, where the client service component has elevated execution privileges. In some examples, a client service component may be included in vehicle control component 144, image capture component 102C, a computing device external to vehicle computing components 134 that access vehicle computing components 132 through device interface 112. For instance, a smartphone may include a client service component that interoperates with vehicle computing components 134 via device interface 112.

Client service component 123 may receive information of code 126 encoded by on-PAAV credential 113 from interpretation component 118 and/or client authentication component 119. For instance, client service component 123 may include one or more interfaces that listen for events from one or more of interpretation component 118, client authentication component 119, and/or any other components of vehicle computing components 134. As an example, as PAAV 110 is traveling along a pathway, image capture device 102C may capture an image of pathway article 108. Interpretation component 118 may determine information of code 126, which may be sent as an event to client authentication component 119, which send the information in encoded form to client service component 128. Client service component 128 may send a request that includes the encoded information of optical code 126 to remote computing device 139. In some examples, if PAAV 110 includes a service credential (e.g., service credential 137), PAAV computing device 116 may determine one or more operations to perform based on the information of code 126, information (e.g., context information, vehicle operation information, etc.) from one or more components in vehicle computing components 134, and/or information from components not included in vehicle computing components 134 (e.g., external smartphone, remote computing device 139, etc.).

In some examples, client service component 128 may determine that operations to be performed include sending a request 131 to remote computing device 139 to access one or more services provided by server service components, such as server service component 130. In such examples, client service component 128 may generate a request 131 (e.g., a message, object, or other structured data) that includes information of code 126 encoded by on-PAAV credential 113, or data generated based at least in part on one or more of information of code 126 and/or on-PAAV credential 113. In some examples, rather than encoding information of optical code 126 with on-PAAV credential 113, client service component may send information of optical code 126 and on-PAAV credential 113 to remote computing device 139.

In some examples, services provided by remote computing device 139 may be accessed through a naming syntax and/or naming service. For instance, client service component 128 may access a service provided by remote computing device 139 using a Uniform Resource Identifier (URI). The URI may correspond to an endpoint of the requested service that receives input values (e.g., credential, information of code 126, etc.) and provides output values based on functionality of the requested service. In some examples, the URI may correspond to a Representational state transfer (REST) service, such that a request submitted to the URI endpoint generates a response 133 with service data provided by the service. Although a URI/REST implementation described in this disclosure, one of skill in the art may implement the techniques of this disclosure using any suitable architectural style and implementation.

In the example of FIG. 1, client service component 128 may send a request 131 to access and/or use a service provided by remote computing device 139 via communication links 115A-115B (“communication links 115”). Communication links 115 may be any number of wired and/or wireless communication links that facilitate and operate as carriers for data transferred between PAAV 110 and remote computing device 139. Examples of communication links may include links that implement IEEE 802.11 (Wifi), 3G/4G/5G, Ethernet, satellite access protocols, Dedicated Short Range Communications (DSCR) protocols, or any other carrier technology for transferring information between PAAV 110 and remote computing device 139. In some examples, network 114 may include one or more additional computing devices coupled via communication links to communication links 115A and/or 115B, where such computing devices may transfer information between PAAV 110 and remote computing device 139. In some examples, network 114 may represent or be a part of the Internet.

Remote computing device 139 represents any suitable computing system, which may be remote from PAAV 110, such as one or more desktop computers, laptop computers, mainframes, servers, cloud computing systems, or any other computing device capable of sending, receiving, and processing information

PAAV 110 may communicate with multiple remote computing devices, such as 134. In some examples, different remote computing devices may provide different services that are controlled, operated, and/or provided by different owners and/or operators of such services. Accordingly, although the example of FIG. 1 is described with respect to remote computing device 139 that provides one or more services controlled and operated by a particular operator, in other examples, many operators may offer their own differentiated services at separate remote computing devices, where such services are based at least in part on a set of one or more credentials (e.g., on-PAAV credential 113) and information of code 126.

Remote computing device 139 may include server authentication component 141 and server service component 130. Remote computing device 124 may execute components 119 and 130 with one or more processors. Remote computing device 124 may execute any of components 119 and 130 as or within a virtual machine executing on underlying hardware. Components 119 and 130 may be implemented in various ways. For example, any of components 119 and 130 may be implemented as a downloadable or pre-installed application or “app.” In another example, any of components 119 and 130 may be implemented as part of an operating system of remote computing device 124. In other examples, remote computing device may include fewer or more components than shown in FIG. 1.

Server authorization component 119 may manage authentication of requests, such as request 131. For instance, server authorization component 119 may include interfaces, drivers, and/or other functionality to process information encoded based on credentials, such as on-PAAV credential 113, in conjunction with information of code 126. When a request is initially received by remote computing device 139, server authentication component 141 may determine whether data in request 131 that is encoded by on-PAAV credential 113 is valid. For instance, server authentication component 141 may attempt to decode request 131 with one or more service credentials, such as service credential 137. Each service may be associated with one or more of PAAVs and/or operators/owners/users/custodians/passengers of PAAVs. For instance, a datastore may include an association between a service credential associated with a credential issued to a PAAV and information about the PAAV. Examples of information about the PAAV may include but are not limited to: manufacturer of PAAV, custodian of PAAV, operator and/or passenger of PAAV or the like. In other examples, any identifier or data may be associated with the service and/or on-PAAV credential. As an example, the service and/or on-PAAV credential may be associated with an identifier of a passenger in a PAAV, a pathway administrator or pathway custodian, a government entity, or any other entity.

In some examples, server authentication component 141 may communicate with a third-party service to validate a credential and/or obtain new credentials for PAAVs or PAAV operators. Server authentication component 141 may manage the lifecycle of credentials, such as creation, deletion, updating, expiration and the like. For example, as a credential expires (e.g., according to periodic schedule, asynchronous event, etc.), server authentication component 141 may generate and/or send an updated credential to vehicle computing components 134 that replaces on-PAAV credential 113.

In some examples, remote computing device 139 may receive other metadata in request 131, which server authentication component 141 may use in conjunction with the credential and/or information of code 126. Examples of such metadata may include but are not limited to: geographic location of PAAV, geographic location of pathway article, vehicle identification number, vehicle model number, vehicle make number, timestamp, data from or relating to vehicles proximity to the PAAV that submitted the request, data from or relating to environments or any other suitable metadata.

In the example of FIG. 1, server authentication component 141 may authenticate request 131. If authentication of request 131 fails, server authentication component 141 may send a response to PAAV 110 indicating that the request is invalid and/or that authentication failed. If authentication of request 131 is successful (e.g., valid credential, information of code 126 and/or combination of credential, code and/or other metadata), then server service component 130 may perform one or more operations to provide a service based on information included in request 131.

Server service component 130 may perform any service, which may include operations such as receiving data, storing data, retrieving data, further processing data, communicating with other computing devices, outputting data, or performing any other operations. Example services may include but are not limited to providing, updating, and/or retrieving: traffic information, roadway condition information, weather information, pathway article information, vehicle history information, emergency information, restaurant or hotel information, law enforcement information, safety information, or any other service.

In operation, if the authentication of request 131 is successful, then server service component 130 may receive the information of code 126. If the on-PAAV credential 113 itself or an identifier (e.g., user identifier, account identifier, etc.) associated with the on-PAAV credential 113 are included in request 131, then service component 130 may receive this information. In the example of FIG. 1, server service component 130 may receive or determine an account identifier associated with on-PAAV credential 113, service credential 137, and/or information of code 126. Server service component 130 may include associations between service identifiers, on-PAAV credential 113, service credential 137, and/or an identifier (e.g., user identifier, account identifier, etc.) associated with the on-PAAV credential 113. Using the account identifier and information of code 126, server service component 139 may perform one or operations of a service based on the account identifier and information of code 126. For example, an operator of PAAV 110 may be a subscriber to a high-precision roadway condition service that provides roadway condition information for pathway locations that is more precise than a GPS radio. In such an example, request 131 may be encoded with credential of the operator or PAAV 110, wherein the request includes information of code 126 comprising an identifier of pathway article 108. Upon request 131 being authenticated by service authentication component 119, server service component 130 may determine a precise location of pathway article 126 and current roadway condition information associated with the precise location of the pathway article. In some examples, the roadway condition information may include a roadway condition and a distance between the roadway condition and the pathway article. In this way, vehicle computing components 134 of PAAV 110 may preemptively operate to respond to an approaching roadway condition as the PAAV 110 determines that PAAV 110 is approaching the condition.

Server service component 130 may generate and/or retrieve service data, which server service component 130 sends in a response 133 to the requestor, e.g., PAAV 110. In the foregoing example, the service data may include the roadway conditions and distances between the roadway conditions and the pathway article. Although roadway conditions are one example of a service in FIG. 1, any other services may be implemented by server service component 130. Communication unit 214 may receive response 133 and provide data, such as service data 133, to client service component 128

Client service component 128 may perform any number of operations based at least in part on service data included in response 133. For instance, client service component 128 may cause UI component 124 to output information based at least in part on service data included in response 133. Examples of outputting service data for display may include displaying points of interest on a graphical map, displaying visual alerts, or otherwise displaying images, animations, videos, or text. In some examples, client service component 128 may cause other output components (not shown), such as an audio speaker or haptic feedback device to generate outputs based on service data of response 133. In some examples, client service component 128 may send information based on response 133 to vehicle control component 144. The information based on response 133 may cause PAAV 110 to change its operation. Examples of operation changes may include but are not limited to: braking, suspension, steering, acceleration, lighting, entertainment, or any other operation that may be performed by PAAV 110.

In some examples, client service component 128 may send information based on service data of response 133 to one or more other vehicles or computing devices. For instance, the one or more other vehicles may be in communication with PAAV 110. In some examples, client service component 128 may only send information based on service data of response 133 to one or more other computing devices that are within a threshold distance of PAAV 110. In some examples, the threshold distance may be machine-defined, user-defined, and/or based on a physical limitation of the communication range at which PAAV 110 can communicate with other computing devices.

Computing device 116 includes vehicle control component 144 to control autonomous operation of PAAV 110. Vehicle control component 144 may be configured to receive information from services provided by remote computing device 139. In some examples, vehicle control component 144 may receive an operating rule set that describes navigational characteristics from remote computing device 139 and based on information of code 126. For example, based on submitting a request that includes information of code 126 and/or on-PAAV credential 113, vehicle control component 144 may receive the operating rule set from client service component 128.

Vehicle control component 144 may be configured to modify, based on the response 133 that includes service data, a mode of autonomous operation of PAAV 110. A mode of autonomous operation may represent a set of autonomous or semi-autonomous responses of PAAV 110 to navigational stimuli received by PAAV 110. For example, PAAV 110 may detect a navigational stimulus from a sensor, such as a lane marker from one of image capture devices 102. Based on characteristics of the lane marker, such as a position of the lane marker with respect to PAAV 110, PAAV 110 may perform a first operation, such as notifying a driver that the lane marker is near, in a first mode of autonomous operation and perform a second operation, such as avoiding the lane marker, in a second mode of operation. As such, a change in a mode of autonomous operation may include changing a response of PAAV 110 to the navigational stimulus, such as through different operating rules or different levels of autonomous operation.

In some examples, such as examples where code 126 indicates an operating rule set, vehicle control component 144 may be configured to modify the mode of autonomous operation by updating a current operating rule set with the operating rule set indicated by code 126. For example, vehicle control component 144 may direct operations of PAAV 110, such as responses of PAAV 110 to navigational stimuli, according to the updated operating rule set. The updated operating rule set may provide vehicle control component 144 with supplemental or replacement operating rules that may be directed toward localized conditions on or proximity to the pathway 106.

In some examples, vehicle control component 144 may be configured to modify the mode of autonomous operation by changing a level of autonomous operation to the level of or within the threshold of autonomous operation specified by data received from services implemented at remote computing device 139. For example, if code 126 indicates a maximum level of autonomous operation permitted for PAAV 110 and vehicle control component 144 is operating PAAV 110 above the maximum level of autonomous operation permitted for PAAV 110, vehicle control component 144 may reduce the level of autonomous operation of the PAAV to the maximum level indicated by code 126. As another example, if code 126 indicates a minimum level of autonomous operation permitted for PAAV 110 and vehicle control component 144 is operating PAAV 110 below the minimum level of autonomous operation permitted for PAAV 110, vehicle control component 144 may determine PAAV 110 does not have a level of autonomous vehicle operation capability to meet the minimum level indicated by code 126 and output an alert to a driver to begin non-autonomous operation of PAAV 110.

Vehicle control component 144 may include, for example, any circuitry or other hardware, or software that may adjust one or more functions of the vehicle. Some examples include adjustments to change a speed of the vehicle, change the status of a headlight, changing a damping coefficient of a suspension system of the vehicle, apply a force to a steering system of the vehicle or change the interpretation of one or more inputs from other sensors. For example, an IR capture device may determine an object near the vehicle pathway has body heat and change the interpretation of a visible spectrum image capture device from the object being a non-mobile structure to a possible large animal that could move into the pathway. Vehicle control component 144 may further control the vehicle speed as a result of these changes. In some examples, the computing device initiates the determined adjustment for one or more functions of PAAV 110 based on the second information in conjunction with a human operator that alters one or more functions of PAAV 110 based on the first information.

In some examples, the mode of autonomous vehicle operation of PAAV 110 is based on at least one of capabilities of one or more sensors of PAAV 110 and capabilities of navigational software of the PAAV. For example, the one or more sensors of PAAV 110 and capabilities of navigational software of PAAV may at least partly determine the navigational capabilities of vehicle control component 144 by determining the type and/or complexity of sensory information from pathway 106 and/or the complexity of navigational decisions based on the sensory information. For example, the capabilities of the one or more sensors and the navigational software include at least one of a minimum version of the navigational software and minimum operating requirements of the one or more sensors. In some examples, the level of autonomous operation corresponds to an industry standard, such as a level of driving autonomation as defined in Society of Automotive Engineers (SAE) International J3016, US National Highway Traffic Safety Administration (NHTSA), and German Federal Highway Research Institute (BASt).

The pathway article of this disclosure may provide redundant information that computing device 116, or a human operator, may consider when operating a vehicle. Other information may include information from other sensors, such as radar or ultrasound distance sensors, lane markings on the vehicle pathway captured from image capture devices 102, information from GPS, and the like. Computing device 116 may consider the various inputs (p) and consider each with a weighting value, such as in a decision equation, as local information to improve the decision process. One possible decision equation may include:

D=w₁*p₁+w₂*p₂+ . . . wₙ*pₙ+w_{PA}*p_{PA}

where the weights (w₁−wₙ) may be a function of the information received from pathway article 108 (p_{PA}). In the example of a construction zone, an enhanced sign may indicate a lane shift from the construction zone. Therefore, computing device 116 may de-prioritize signals from lane marking detection systems when operating the vehicle in the construction zone.

In some examples, access to and use of a remote service 130 may be based on the on-PAAV credential 113 and a service credential 137 associated with remote service 130. For instance, request 131 from PAAV 110 that is received by remote service 130 may be encoded by on-PAAV credential 113 or include on-PAAV credential 113 itself. Remote service 130 may provide response 133 to PAAV 110 if a combination of on-PAAV credential 113 and service credential 137 provide valid authentication to the remote service. For instance, on-PAAV credential 113 and service credential 137 may be generated by or otherwise processed by a hash-function, one-way function, or any other cryptographic function such that is can be determined by a computing device that the combination of credential 113 and service credential 137 provide validate authentication. If the combination of on-PAAV credential 113 and the service credential 137 do not provide valid authentication to remote service 130, then remote service 130 may not provide a response based on further processing the request by the service. In some examples, the on-PAAV credential and service credential may be independently generated and controlled by separate entities or operators, while in other examples, on-PAAV credential 113 may be based on service credential 137 or service credential 137 may be based on on-PAAV credential 113.

In some examples, remote computing device 139 may host multiple services and one or more of the services may be operated by one or more different operators that manage service credentials associated with such services. In such examples, server authentication component 141 and/or server service component 130 may determine whether a combination of on-PAAV credential 113 and service credential 137 provide valid authentication to access the service provided by server service component 130. If a controller, owner, or custodian of on-PAAV credential 113 has paid or obtained approval from the operator of server service component 130 to access a remote service provided by server service component 130, then the operator of server service component 130 may configure access to the remote service provided by server service component 130 based on a combination of on-PAAV credential 113 and server service component 130.

In some examples, information of code 126 of pathway article 108 may include open code 126 and closed code 127. In some examples, information of closed code 127 may be encoded with on-PAAV credential 113, while open code 127 may not be encoded with on-PAAV credential 113. Each of open code 127 and closed code 128 may be included in request 131. In some examples, information of closed code 127 may be a string of characters, a bitstring, a set of one or more characters or symbols, machine-interpretable compiled or encoded information, or any other information. In some examples, information of closed code 127 may be sent in request 131. In some examples, server authentication component 141 and/or server service component 130 only provide access to the remove service provided by server service component 130 if a combination two or more of data encoded by on-PAAV credential 113, information of closed code 127, and/or service credential 137 represent a combination for valid authentication. In some examples, a different type of service and/or data generated in the response is provided in a response generated by server service component 130 if information of closed code 127 is included in request 131.

In some examples, a PAAV and/or user/operator/custodian of the PAAV with an on-PAAV credential may generate and/or send a Unique User Identifier (UUID) to remote computing device 139 that is based on a function f(on-PAAV credential, {UUID parameters}). A different PAAV and/or user/operator/custodian of the PAAV without an on-PAAV credential may generate and/or send a UUID to remote computing device 139 that is based on a function f({UUID parameters}). UUID parameters may be any parameters usable to generate a UUID, such as but not limited to: pathway article type, pathway article location, vehicle type, vehicle identifier, user identifier, or any other suitable parameters. The function ƒ( ) may be any function for generating a UUID such as but not limited to: a concatenation function, a hash function, an encoding function, or any other suitable function. Remote computing device 139 may perform different operations based on the value of the UUID. Accordingly, different remote services and/or functions of remote services may be provided based on whether an on-PAAV credential was used to generate the UUID. In this way, vehicles without an on-PAAV credential may access certain services (e.g., basic or publicly accessible services), while other differentiated services may be provided to users/operators/custodians of PAAVs where an on-PAAV credential is configured or available for use in requests to remote services.

Although FIG. 1 has been described with respect to a remote service implemented at remote computing device 139, any functionality or portion of functionality of remote computing device 139 may be implemented at PAAV 110. For instance, server authentication component 141, server service component 130 and/or service credential 137 may be implemented as vehicle computing components 134. In such examples, requests and responses may be communicated using one or more communication channels implemented within PAAV 110, rather than communication links 115 and/or network 113.

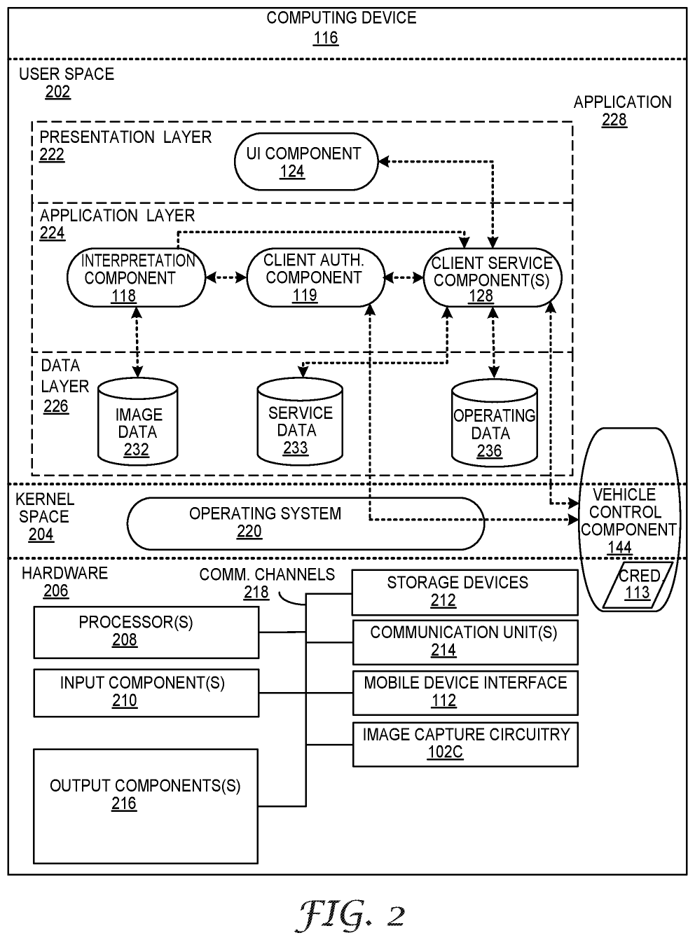

FIG. 2 is a block diagram illustrating an example computing device, in accordance with one or more aspects of the present disclosure. FIG. 2 illustrates only one example of a computing device. Many other examples of computing device 116 may be used in other instances and may include a subset of the components included in example computing device 116 or may include additional components not shown example computing device 116 in FIG. 2.

In some examples, computing device 116 may be a server, tablet computing device, smartphone, wrist- or head-worn computing device, laptop, desktop computing device, or any other computing device that may run a set, subset, or superset of functionality included in application 228. In some examples, computing device 116 may correspond to vehicle computing device 116 onboard PAAV 110, depicted in FIG. 1. In FIG. 2, various components of vehicle computing components 134 are included within computing device 116, although in other examples, certain vehicle computing components 134 could be configured outside of computing device 116, such as shown in FIG. 1. One of ordinary skill in the art may implement any number of different architectures for computing device 116 that include or distribute various components. In other examples, computing device 116 may also be part of a system or device that determines one or more operating rule sets and may correspond to remote computing device 139 depicted in FIG. 1. In some examples, computing device 116 may represent be a single physical computing device or may represent a set of physical computing devices that collectively include the functionality of computing device 116 as shown in FIG. 2.

As shown in the example of FIG. 2, computing device 116 may be logically divided into user space 202, kernel space 204, and hardware 206. Hardware 206 may include one or more hardware components that provide an operating environment for components executing in user space 202 and kernel space 204. User space 202 and kernel space 204 may represent different sections or segmentations of memory, where kernel space 204 provides higher privileges to processes and threads than user space 202. For instance, kernel space 204 may include operating system 220, which operates with higher privileges than components executing in user space 202. Although certain components are shown as residing within or implemented in user space 202, kernel space 204, or hardware 206, in other examples, such components may reside or be implemented within other logical divisions (e.g., client authentication component 119 may be implemented in kernel space 204 and/or hardware 206 although illustrated in user space 202 for example purposes of FIG. 2).

As shown in FIG. 2, hardware 206 includes one or more processors 208, input components 210, storage devices 212, communication units 214, output components 216, device interface 112, and image capture component 102C. Processors 208, input components 210, storage devices 212, communication units 214, output components 216, device interface 112, and image capture component 102C may each be interconnected by one or more communication channels 218. Communication channels 218 may interconnect each of the components 102C, 104, 208, 210, 212, 214, and 216 for inter-component communications (physically, communicatively, and/or operatively). In some examples, communication channels 218 may include a hardware bus, a network connection, one or more inter-process communication data structures, or any other components for communicating data between hardware and/or software.

One or more processors 208 may implement functionality and/or execute instructions within computing device 116. For example, processors 208 on computing device 116 may receive and execute instructions stored by storage devices 212 that provide the functionality of components included in kernel space 204 and user space 202. These instructions executed by processors 208 may cause computing device 116 to store and/or modify information, within storage devices 212 during program execution. Processors 208 may execute instructions of components in kernel space 204 and user space 202 to perform one or more operations in accordance with techniques of this disclosure. That is, components included in user space 202 and kernel space 204 may be operable by processors 208 to perform various functions described herein.

One or more input components 210 of computing device 116 may receive input. Examples of input are tactile, audio, kinetic, and optical input, to name only a few examples. Input components 210 of computing device 116, in one example, include a mouse, keyboard, voice responsive system, video camera, buttons, control pad, microphone or any other type of device for detecting input from a human or machine. In some examples, input component 210 may be a presence-sensitive input component, which may include a presence-sensitive screen, touch-sensitive screen, etc.

One or more communication units 214 of computing device 116 may communicate with external devices by transmitting and/or receiving data. For example, computing device 116 may use communication units 214 to transmit and/or receive radio signals on a radio network such as a cellular radio network. In some examples, communication units 214 may transmit and/or receive satellite signals on a satellite network such as a Global Positioning System (GPS) network. Examples of communication units 214 include a network interface card (e.g. such as an Ethernet card), an optical transceiver, a radio frequency transceiver, a GPS receiver, or any other type of device that can send and/or receive information. Other examples of communication units 214 may include Bluetooth®, GPS, 3G, 4G, and Wi-Fi® radios found in mobile devices as well as Universal Serial Bus (USB) controllers and the like.

In some examples, communication units 214 may receive data that includes information regarding a vehicle pathway, such as an operating rule set for navigating the vehicle pathway or a level of autonomous control of the vehicle pathway. In examples where computing device 116 is part of a vehicle, such as PAAV 110 depicted in FIG. 1, communication units 214 may receive information about a pathway article from an image capture device, as described in relation to FIG. 1. In other examples, such as examples where computing device 116 is part of a system or device that determines one or more operating rule sets, communication units 214 may receive data from a test vehicle, handheld device or other means that may gather data that indicates the navigational characteristics of a vehicle pathway, as described above in FIG. 1 and in more detail below. Computing device 116 may receive updated information, upgrades to software, firmware and similar updates via communication units 214.

One or more output components 216 of computing device 116 may generate output. Examples of output are tactile, audio, and video output. Output components 216 of computing device 116, in some examples, include a presence-sensitive screen, sound card, video graphics adapter card, speaker, cathode ray tube (CRT) monitor, liquid crystal display (LCD), or any other type of device for generating output to a human or machine. Output components may include display components such as cathode ray tube (CRT) monitor, liquid crystal display (LCD), Light-Emitting Diode (LED) or any other type of device for generating tactile, audio, and/or visual output. Output components 216 may be integrated with computing device 116 in some examples.

In other examples, output components 216 may be physically external to and separate from computing device 116, but may be operably coupled to computing device 116 via wired or wireless communication. An output component may be a built-in component of computing device 116 located within and physically connected to the external packaging of computing device 116 (e.g., a screen on a mobile phone). In another example, a presence-sensitive display may be an external component of computing device 116 located outside and physically separated from the packaging of computing device 116 (e.g., a monitor, a projector, etc. that shares a wired and/or wireless data path with a tablet computer).

Output components 216 may also include vehicle control component 144, in examples where computing device 116 is onboard a PAAV. Vehicle control component 144 has the same functions as vehicle control component 144 described in relation to FIG. 1.

One or more storage devices 212 within computing device 116 may store information for processing during operation of computing device 116. In some examples, storage device 212 is a temporary memory, meaning that a primary purpose of storage device 212 is not long-term storage. Storage devices 212 on computing device 116 may configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art.

Storage devices 212, in some examples, also include one or more computer-readable storage media. Storage devices 212 may be configured to store larger amounts of information than volatile memory. Storage devices 212 may further be configured for long-term storage of information as non-volatile memory space and retain information after activate/off cycles. Examples of non-volatile memories include magnetic hard discs, optical discs, floppy discs, flash memories, or forms of electrically programmable memories (EPROM) or electrically erasable and programmable (EEPROM) memories. Storage devices 212 may store program instructions and/or data associated with components included in user space 202 and/or kernel space 204.

As shown in FIG. 2, application 228 executes in user space 202 of computing device 116. Application 228 may be logically divided into presentation layer 222, application layer 224, and data layer 226. Presentation layer 222 may include user interface (UI) component 228, which generates and renders user interfaces of application 228. Application 228 may include, but is not limited to: UI component 124, interpretation component 118, client authentication component 119, and client service component 128. Application layer 224 may include interpretation component 118, client authentication component 119, and client service component 128.

Data layer 226 may include one or more datastores. A datastore may store data in structure or unstructured form. Example datastores may be any one or more of a relational database management system, online analytical processing database, table, or any other suitable structure for storing data.

Image data 232 may include one or more images of code 126 that are received from one or more image capture devices, such as image capture devices 102 described in relation to FIG. 1. In some examples, the images are bitmaps, Joint Photographic Experts Group images (JPEGs), Portable Network Graphics images (PNGs), or any other suitable graphics file formats. In other examples, image data 232 may include metadata or parameterized data that is descriptive of the image itself.

Service data 233 may include any data to provide and/or resulting from a service of client service component 128. For instance, service data may include information about pathway articles (e.g., security specifications), user information, operating rule sets, levels of autonomous operation, or any other information transmitted between one or more components of computing device 116 and/or sent or received with one or more services of remote computing device 139 as shown in FIG. 1. Operating data 236 may include instructions for operating PAAV 110. Operating data may include one or more operating rule sets, one or more operating protocols for various levels of autonomous operation, and the like.

In the example of FIG. 2, one or more of communication units 214 may receive, from an image capture device, an image of a pathway article that includes a code, such as code 126 in FIG. 1. In some examples, UI component 124 or any one or more components of application layer 224 may receive the image of code 126 and store the image in image data 232.

In response to receiving the image of code 126, interpretation component 118 may process the image of code 126 to obtain code 126. Code 126 may indicate information related to a pathway article, the pathway, an object on or along the pathway, or any other information. Interpretation component 118 may interpret code 126 to obtain the information, such as by using decoding information from image data 232. Interpretation component 118 may provide the information to client authentication component 119 and/or client service component 128.

Client authentication component 119, as described in FIG. 1, may use one or more credentials to encode code 126 that is sent by client service component 128 to a service of remote computing device 139. In some examples, client authentication component 119 may receive information of code 126 and send both code 126 and the one or more credentials to client service component 128. In other examples, client service component 128 may receive information of code 126 from interpretation component 118, and request the one or more credentials from client authentication component 119 for inclusion in the request.

Client service component 128 may generate requests and initiate sending of such requests to services of remote computing device 139. Client service component 128 may receive responses from services of remote computing device 139 and further process service data from such responses at computing device 116. In some examples, client service components 128 may store data in service data 233 and/or operating data 236. In some examples, client service components 128 may retrieve data from service data 233, operating data 236, and/or other sources of data (whether residing locally at computing device 116 and/or remotely accessible at one or more remote computing devices).

In some examples, client service component 128 may receive data from a service and send such data or information based on such data to vehicle control component 144, UI component 124, and/or one or more other components of computing device 116. Although communication between vehicle control component 144 and application 228 is illustrated via operating system 220, in other examples, such communication may occur without operating system 220 and/or using one or more other communication channels and/or mechanisms to send and receive data. Vehicle control component 144 is further illustrated in FIG. 2 as including portions of functionality that may operate and/or be implemented in one or more of user space 202, kernel space 204, and/or hardware 206. In some examples, vehicle control component 144 may be implemented entirely in hardware 206, or executing in a combination of kernel space 204 and user space 202. Any implemented and/or combination within the skill of one of ordinary skill in the art may be used.

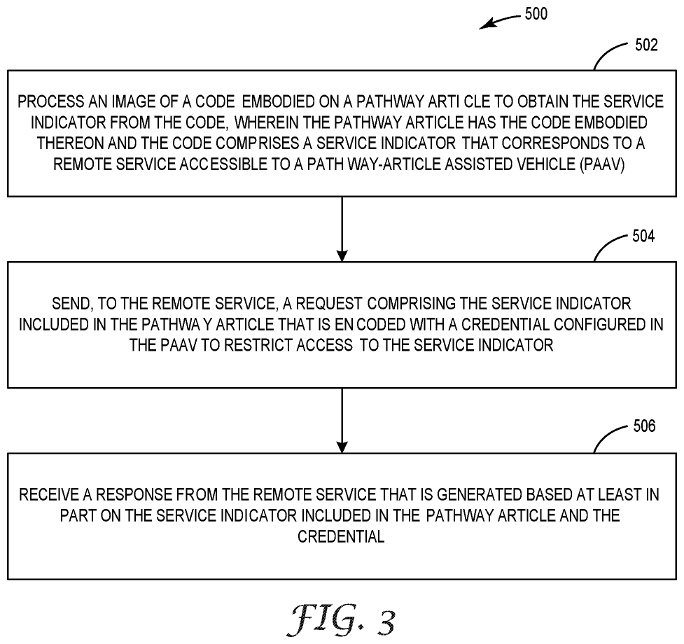

FIG. 3 is a flow diagram illustrating example operations of a computing device, in accordance with one or more techniques of this disclosure. The techniques are described in terms of computing device 116 of FIG. 1. However, the techniques may be performed by other computing devices, such as remote computing device 139.

In the example of FIG. 3, computing device 116 receives an image of code 126 from image capture component 102C. Computing device 116 may process the image of code 126 embodied on pathway article 108 to obtain the service indicator from code 126. In some examples, pathway article 108 includes code 126 embodied thereon and is positioned proximate to vehicle pathway 106. Code 126 may include a service indicator that corresponds to a remote service accessible to pathway-article assisted vehicle (PAAV) 110.

Computing device 116 may send, to the remote service, a request comprising the service indicator included in the pathway article that is encoded with a credential configured in the PAAV to restrict access to the service indicator. Computing device 116 may receive response 133 from the remote service that is generated by remote computing device 139 based at least in part on the service indicator included in code 126 of pathway article 108 and the credential.

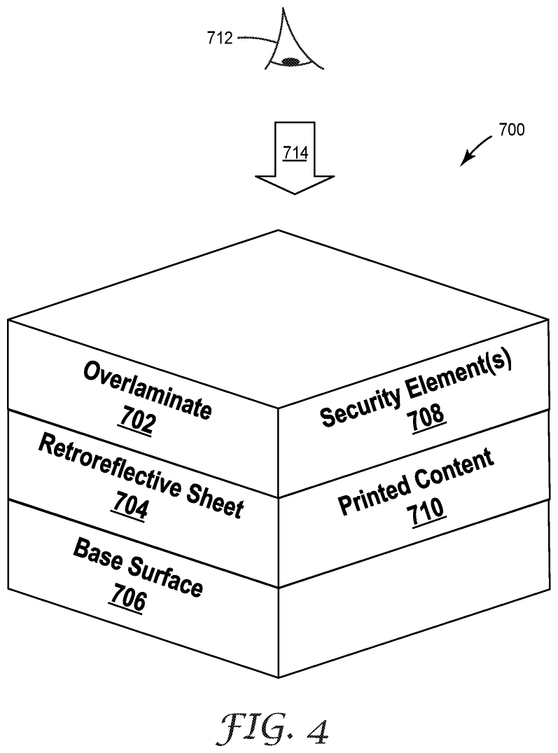

FIG. 4 is a conceptual diagram of a cross-sectional view of a pathway article in accordance with techniques of this disclosure. In some examples, such as an enhanced sign, a pathway article may comprise multiple layers. For purposes of illustration in FIG. 4, a pathway article 700 may include a base surface 706. Base surface 706 may be an aluminum plate or any other rigid, semi-rigid, or flexible surface. Retroreflective sheet 704 may be a retroreflective sheet as described in this disclosure. A layer of adhesive (not shown) may be disposed between retroreflective sheet 704 and base surface 706 to adhere retroreflective sheet 704 to base surface 706.

Pathway article may include an overlaminate 702 that is formed or adhered to retroreflective sheet 704. Overlaminate 702 may be constructed of a visibly-transparent, infrared opaque material, such as but not limited to multilayer optical film as disclosed in U.S. Pat. No. 8,865,293, which is expressly incorporated by reference herein in its entirety. In some construction processes, retroreflective sheet 704 may be printed and then overlaminate 702 subsequently applied to reflective sheet 704. A viewer 712, such as a person or image capture device, may view pathway article 700 in the direction indicated by the arrow 714.

As described in this disclosure, in some examples, an article message, such as code 126 of FIG. 1, may be printed or otherwise included on a retroreflective sheet. In such examples, an overlaminate may be applied over the retroreflective sheet, but the overlaminate may not contain an article message. In the example of FIG. 4, visible portions 710 of the article message may be included in retroreflective sheet 704, but non-visible portions 708 of the article message may be included in overlaminate 702. In some examples, a non-visible portion may be created from or within a visibly-transparent, infrared opaque material that forms an overlaminate. European publication No. EP0416742 describes recognition symbols created from a material that is absorptive in the near infrared spectrum but transparent in the visible spectrum. Suitable near infrared absorbers/visible transmitter materials include dyes disclosed in U.S. Pat. No. 4,581,325. U.S. Pat. No. 7,387,393 describes license plates including infrared-blocking materials that create contrast on a license plate. U.S. Pat. No. 8,865,293 describes positioning an infrared-reflecting material adjacent to a retroreflective or reflective substrate, such that the infrared-reflecting material forms a pattern that can be read by an infrared sensor when the substrate is illuminated by an infrared radiation source. EP0416742 and U.S. Pat. Nos. 4,581,325, 7,387,393 and 8,865,293 are herein expressly incorporated by reference in their entireties. In some examples, overlaminate 702 may be etched with one or more visible or non-visible portions.

In some examples, if overlaminate includes non-visible portions 708 and retroreflective sheet 704 includes visible portions 710 of article message, an image capture device may capture two separate images, where each separate image is captured under a different lighting spectrum or lighting condition. For instance, the image capture device may capture a first image under a first lighting spectrum that spans a lower boundary of infrared light to an upper boundary of 900 nm. The first image may indicate which encoding units are active or inactive. The image capture device may capture a second image under a second lighting spectrum that spans a lower boundary of 900 nm to an upper boundary of infrared light. The second image may indicate which portions of the article message are active or inactive (or present or not present). Any suitable boundary values may be used. In some examples, multiple layers of overlaminate, rather than a single layer of overlaminate 702, may be disposed on retroreflective sheet 704. One or more of the multiple layers of overlaminate may have one or more portions of the article message. Techniques described in this disclosure with respect to the article message may be applied to any of the examples described in FIG. 4 with multiple layers of overlaminate.

In some examples, a laser in a construction device may engrave the article message onto sheeting, which enables embedding markers specifically for predetermined meanings. Example techniques are described in U.S. Provisional Patent Application 62/264,763, filed on Dec. 8, 2015, which is hereby incorporated by reference in its entirety. In such examples, the portions of the article message in the pathway article can be added at print time, rather than being encoded during sheeting manufacture. In some examples, an image capture device may capture an image in which the engraved security elements or other portions of the article message are distinguishable from other content of the pathway article. In some examples the article message may be disposed on the sheeting at a fixed location while in other examples, the article message may be disposed on the sheeting using a mobile construction device, as described above.

The following examples provide other techniques for creating portions of the article message in a pathway article, in which some portions, when captured by an image capture device, may be distinguishable from other content of the pathway article. For instance, a portion of an article message, such as a security element may be created using at least two sets of indicia, wherein the first set is visible in the visible spectrum and substantially invisible or non-interfering when exposed to infrared radiation; and the second set of indicia is invisible in the visible spectrum and visible (or detectable) when exposed to infrared. Patent Publication WO/2015/148426 (Pavelka et al) describes a license plate comprising two sets of information that are visible under different wavelengths. The disclosure of WO/2015/148426 is expressly incorporated herein by reference in its entirety. In yet another example, a security element may be created by changing the optical properties of at least a portion of the underlying substrate. U.S. Pat. No. 7,068,434 (Florczak et al), which is expressly incorporated by reference in its entirety, describes forming a composite image in beaded retroreflective sheet, wherein the composite image appears to be suspended above or below the sheeting (e.g., floating image). U.S. Pat. No. 8,950,877 (Northey et al), which is expressly incorporated by reference in its entirety, describes a prismatic retroreflective sheet including a first portion having a first visual feature and a second portion having a second visual feature different from the first visual feature, wherein the second visual feature forms a security mark. The different visual feature can include at least one of retroreflectance, brightness or whiteness at a given orientation, entrance or observation angle, as well as rotational symmetry. Patent Publication No. 2012/281285 (Orensteen et al), which is expressly incorporated by reference in its entirety, describes creating a security mark in a prismatic retroreflective sheet by irradiating the back side (i.e., the side having prismatic features such as cube corner elements) with a radiation source. U.S. Patent Publication No. 2014/078587 (Orensteen et al), which is expressly incorporated by reference in its entirety, describes a prismatic retroreflective sheet comprising an optically variable mark. The optically variable mark is created during the manufacturing process of the retroreflective sheet, wherein a mold comprising cube corner cavities is provided. The mold is at least partially filled with a radiation curable resin and the radiation curable resin is exposed to a first, patterned irradiation. Each of U.S. Pat. Nos. 7,068,464, 8,950,877, US 2012/281285 and US 2014/078587 are expressly incorporated by reference in its entirety.

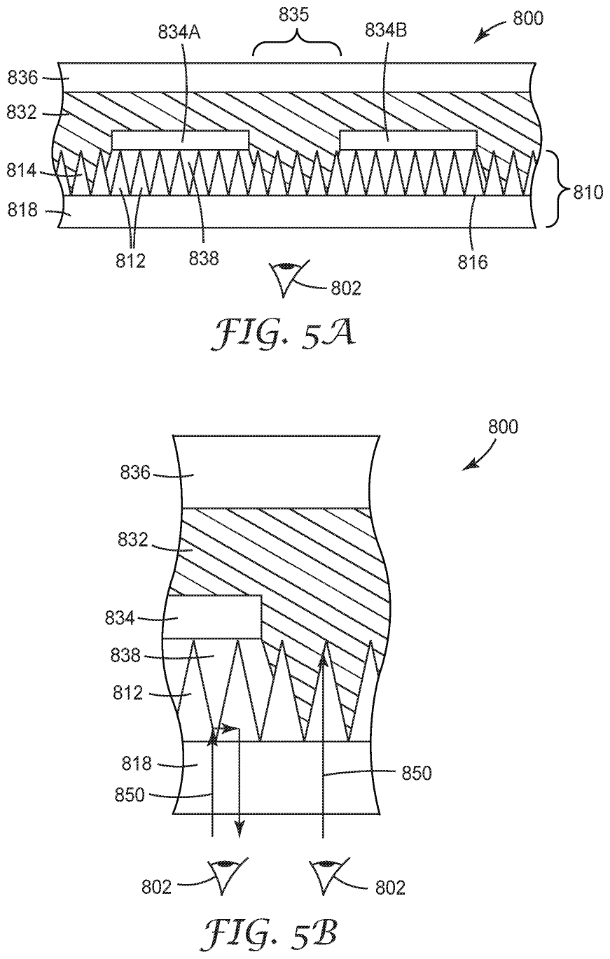

FIGS. 5A and 5B illustrate cross-sectional views of portions of an article message formed on a retroreflective sheet, in accordance with one or more techniques of this disclosure. Retroreflective article 800 includes a retroreflective layer 810 including multiple cube corner elements 812 that collectively form a structured surface 814 opposite a major surface 816. The optical elements can be full cubes, truncated cubes, or preferred geometry (PG) cubes as described in, for example, U.S. Pat. No. 7,422,334, incorporated herein by reference in its entirety. The specific retroreflective layer 810 shown in FIGS. 5A and 5B includes a body layer 818, but those of skill will appreciate that some examples do not include an overlay layer. One or more barrier layers 834 are positioned between retroreflective layer 810 and conforming layer 832, creating a low refractive index area 838. Barrier layers 834 form a physical “barrier” between cube corner elements 812 and conforming layer 832. Barrier layer 834 can directly contact or be spaced apart from or can push slightly into the tips of cube corner elements 812. Barrier layers 834 have a characteristic that varies from a characteristic in one of (1) the areas 832 not including barrier layers (view line of light ray 850) or (2) another barrier layer 832. Exemplary characteristics include, for example, color and infrared absorbency.

In general, any material that prevents the conforming layer material from contacting cube corner elements 812 or flowing or creeping into low refractive index area 838 can be used to form the barrier layer Exemplary materials for use in barrier layer 834 include resins, polymeric materials, dyes, inks (including color-shifting inks), vinyl, inorganic materials, UV-curable polymers, multi-layer optical films (including, for example, color-shifting multi-layer optical films), pigments, particles, and beads. The size and spacing of the one or more barrier layers can be varied. In some examples, the barrier layers may form a pattern on the retroreflective sheet. In some examples, one may wish to reduce the visibility of the pattern on the sheeting. In general, any desired pattern can be generated by combinations of the described techniques, including, for example, indicia such as letters, words, alphanumerics, symbols, graphics, logos, or pictures. The patterns can also be continuous, discontinuous, monotonic, dotted, serpentine, any smoothly varying function, stripes, varying in the machine direction, the transverse direction, or both; the pattern can form an image, logo, or text, and the pattern can include patterned coatings and/or perforations. The pattern can include, for example, an irregular pattern, a regular pattern, a grid, words, graphics, images lines, and intersecting zones that form cells.

The low refractive index area 838 is positioned between (1) one or both of barrier layer 834 and conforming layer 832 and (2) cube corner elements 812. The low refractive index area 838 facilitates total internal reflection such that light that is incident on cube corner elements 812 adjacent to a low refractive index area 838 is retroreflected. As is shown in FIG. 5B, a light ray 850 incident on a cube corner element 812 that is adjacent to low refractive index layer 838 is retroreflected back to viewer 802. For this reason, an area of retroreflective article 800 that includes low refractive index layer 838 can be referred to as an optically active area. In contrast, an area of retroreflective article 800 that does not include low refractive index layer 838 can be referred to as an optically inactive area because it does not substantially retroreflect incident light. As used herein, the term “optically inactive area” refers to an area that is at least 50% less optically active (e.g., retroreflective) than an optically active area. In some examples, the optically inactive area is at least 40% less optically active, or at least 30% less optically active, or at least 20% less optically active, or at least 10% less optically active, or at least at least 5% less optically active than an optically active area.

Low refractive index layer 838 includes a material that has a refractive index that is less than about 1.30, less than about 1.25, less than about 1.2, less than about 1.15, less than about 1.10, or less than about 1.05. In general, any material that prevents the conforming layer material from contacting cube corner elements 812 or flowing or creeping into low refractive index area 838 can be used as the low refractive index material. In some examples, barrier layer 834 has sufficient structural integrity to prevent conforming layer 832 from flowing into a low refractive index area 838. In such examples, low refractive index area may include, for example, a gas (e.g., air, nitrogen, argon, and the like). In other examples, low refractive index area includes a solid or liquid substance that can flow into or be pressed into or onto cube corner elements 812. Exemplary materials include, for example, ultra-low index coatings (those described in PCT Patent Application No. PCT/US2010/031290), and gels.

The portions of conforming layer 832 that are adjacent to or in contact with cube corner elements 812 form non-optically active (e.g., non-retroreflective) areas or cells. In some examples, conforming layer 832 is optically opaque. In some examples conforming layer 832 has a white color.

In some examples, conforming layer 832 is an adhesive. Exemplary adhesives include those described in PCT Patent Application No. PCT/US2010/031290. Where the conforming layer is an adhesive, the conforming layer may assist in holding the entire retroreflective construction together and/or the viscoelastic nature of barrier layers 834 may prevent wetting of cube tips or surfaces either initially during fabrication of the retroreflective article or over time.

In some examples, conforming layer 832 is a pressure sensitive adhesive. The PSTC (pressure sensitive tape council) definition of a pressure sensitive adhesive is an adhesive that is permanently tacky at room temperature which adheres to a variety of surfaces with light pressure (finger pressure) with no phase change (liquid to solid). While most adhesives (e.g., hot melt adhesives) require both heat and pressure to conform, pressure sensitive adhesives typically only require pressure to conform. Exemplary pressure sensitive adhesives include those described in U.S. Pat. No. 6,677,030. Barrier layers 834 may also prevent the pressure sensitive adhesive from wetting out the cube corner sheeting. In other examples, conforming layer 832 is a hot-melt adhesive.

In some examples, a pathway article may use a non-permanent adhesive to attach the article message to the base surface. This may allow the base surface to be re-used for a different article message. Non-permanent adhesive may have advantages in areas such as roadway construction zones where the vehicle pathway may change frequently.

In the example of FIG. 5A, a non-barrier region 835 does not include a barrier layer, such as barrier layer 834. As such, light may reflect with a lower intensity than barrier layers 834A-834B. In some examples, non-barrier region 835 may correspond to an “active” security element. For instance, the entire region or substantially all of image region 142A may be a non-barrier region 835. In some examples, substantially all of image region 142A may be a non-barrier region that covers at least 50% of the area of image region 142A. In some examples, substantially all of image region 142A may be a non-barrier region that covers at least 75% of the area of image region 142A. In some examples, substantially all of image region 142A may be a non-barrier region that covers at least 90% of the area of image region 142A. In some examples, a set of barrier layers (e.g., 834A, 834B) may correspond to an “inactive” security element. In the aforementioned example, an “inactive” security element may have its entire region or substantially all of image region 142D filled with barrier layers. In some examples, substantially all of image region 142D may be a non-barrier region that covers at least 75% of the area of image region 142D. In some examples, substantially all of image region 142D may be a non-barrier region that covers at least 90% of the area of image region 142D. In the foregoing description of FIG. 5 with respect to security layers, in some examples, non-barrier region 835 may correspond to an “inactive” security element while an “active” security element may have its entire region or substantially all of image region 142D filled with barrier layers.

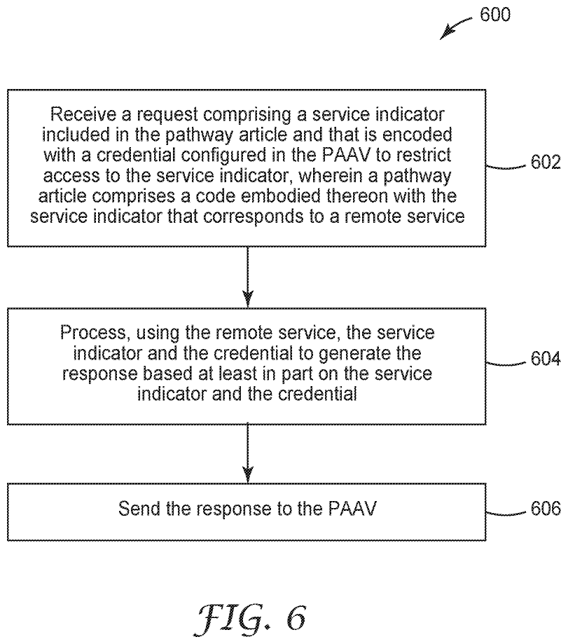

FIG. 6 is a flow diagram illustrating example operations 600 of a computing device, in accordance with one or more techniques of this disclosure. The techniques are described in terms of remote computing device 139 of FIG. 1. However, the techniques may be performed by other computing devices, such as computing device 116.

In the example of FIG. 6, remote computing device 139 receives request 131 comprising a service indicator included in code 126 of pathway article 108 that is encoded with a credential configured in PAAV 110 to restrict access to the service indicator. Pathway article 108 may include code 126 embodied thereon and positioned proximate to vehicle pathway 106. Code 126 may include the service indicator that corresponds to a remote service provided by remote computing device 139 that is accessible to pathway-article assisted vehicle (PAAV) 110. Remote computing device 129 may process, using the remote service provided by service server component 130, the service indicator and the credential to generate response 133 based at least in part on the service indicator and the credential. Remote computing device 139 may send the response to the PAAV.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor”, as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

It is to be recognized that depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, e.g., through multi-threaded processing, interrupt processing, or multiple processors, rather than sequentially.

In some examples, a computer-readable storage medium includes a non-transitory medium. The term “non-transitory” indicates, in some examples, that the storage medium is not embodied in a carrier wave or a propagated signal. In certain examples, a non-transitory storage medium stores data that can, over time, change (e.g., in RAM or cache).

Various examples have been described. These and other examples are within the scope of the following claims.

1. A system comprising:
a pathway article having a code embodied thereon and positioned proximate to a vehicle pathway, wherein the code comprises a service indicator that corresponds to a remote service accessible to a pathway-article assisted vehicle (PAAV); and
the pathway-article assisted vehicle (PAAV) comprising:
at least one image capture device configured to generate an image of the code embodied on the vehicle pathway;
a computing device configured to:
process the image to obtain the service indicator from the code;
send, to the remote service, a request comprising the service indicator included in the pathway article that is encoded with a credential configured in the PAAV to restrict access to the service indicator; and
receive a response from the remote service that is generated based at least in part on the service indicator included in the pathway article and the credential.

2. The system of claim 1, wherein the service indicator comprises an identifier that corresponds to at least one of the pathway article or the remote service.

3. The system of claim 1, wherein the image capture device comprises a light sensor array and image circuitry, wherein the image circuitry stores the credential.

4. The system of claim 1, where the remote service is included at a computing device that is external to the PAAV.

5. The system of claim 1, wherein the credential is at least one of a symmetric key, a public key, or a private key.

6. The system of claim 1, wherein the computing device is configured to modify, based at least in part on data included in the response from the remote service, one or more operations of the PAAV.

7. The system of claim 6, wherein the data included in the response from the remote service indicates a maximum level of autonomous operation permitted for the PAAV, and
wherein, to change one or more operations of the PAAV, the computing device is configured to configure a level of autonomous operation of the PAAV that satisfies a level indicated by the data.

8. The system of claim 1 further comprising a remote computing device configured to:
receive the request comprising the service indicator included in the pathway article and the credential;
process the service indicator and the credential to generate the response based at least in part on the service indicator and the credential; and
send the response to the PAAV.

9. The system of claim 8, wherein the remote computing device is configured to:
store data that indicates an association between the credential and an operator of the PAAV;
store data that indicates an association between the operator and the remote service;
in response to receiving the request, determine the operator associated with the credential;
in response to determining the operator associated with the credential, determine the service associated with the operator; and
wherein to generate the response, the remote computing device is configured to process the service indicator based at least in part on determining the service associated with the operator.

10. The system of claim 8, wherein the remote computing device is configured to:
store data that indicates an association between a first operator of the PAAV and the credential; and
update, in response to determining that a second operator has obtained custody of the PAAV, the data to indicate an association between a second operator of the PAAV and the credential.

11. The system of claim 1, wherein the request is a first request, wherein the computing device is configured to:
send a second request comprising information that is based at least in part on the code embodied on the vehicle pathway article, wherein the request does not comprise the credential.

12. The system of claim 1, wherein the service indicator comprises at least a portion of a Uniform Resource Identifier.

13. The system of claim 8, wherein the credential is an on-PAAV credential, wherein the remote computing device is configured to:
select a service credential that is associated with the remote service;
authenticate the request the remote service based on the service credential and the on-PAAV credential; and
in response to the authentication of the request, process the service indicator to generate the response; and
send the response to the PAAV.

14. The system of claim 13, wherein the on-PAAV credential is generated based at least in part on the service credential.

15. The system of claim 13, wherein the service credential is generated based at least in part on the on-PAAV credential.

16. The system of claim 13, wherein the credential configured in the PAAV is configured in one or more of a head unit computing device of the PAAV or a computing device communicatively coupled to the head unit computing device.

17. A method comprising:
processing, by a computing device, an image of a code embodied on a pathway article to obtain the service indicator from the code, wherein the pathway article has the code embodied thereon and is positioned proximate to a vehicle pathway, wherein the code comprises a service indicator that corresponds to a remote service accessible to a pathway-article assisted vehicle (PAAV);
sending, by the computing device and to the remote service, a request comprising the service indicator included in the pathway article that is encoded with a credential configured in the PAAV to restrict access to the service indicator; and
receiving a response from the remote service that is generated based at least in part on the service indicator included in the pathway article and the credential.

18-42. (canceled)

43. An article comprising:
a physical surface having a code embodied thereon, wherein the code is detectable by at least one image capture device mounted at a pathway-article assisted vehicle (PAAV), and wherein the code is encoded to cause a computing device to receive a response from a remote service that is generated based at least in part on a request that includes service indicator from the code included in the pathway article that is encoded with a credential configured at the PAAV to restrict access to the service indicator.

44-45. (canceled)

46. The article of claim 43, further comprising:
a sheeting comprising the physical surface;
wherein the pathway article includes a base surface,
wherein the sheeting is attached to the base surface of the pathway article, and
wherein the sheeting includes the authentication information.

47. (canceled)

48. The article of claim 43, wherein the code is a first code, wherein the article further comprises
wherein the first code and the second code are encoded to cause a computing device to receive a response from a remote service that is generated based at least in part on a request that includes service indicator from the first and second codes included in the pathway article and a credential configured at the PAAV.
